(19) United States
(12) Patent Application Publication
(10) Pub. No.: US 2012/0175525 A1
(43) Pub. Date: Jul. 12, 2012

(54) HIGH PERFORMANCE NEUTRON DETECTOR WITH NEAR ZERO GAMMA CROSS TALK

(75) Inventor: DAVID L. FRANK, Boca Raton, FL (US)

(73) Assignee: Innovative American Technology, Inc., Coconut Creek, FL (US)

(21) Appl. No.: 12/483,066

(22) Filed: Jun. 11, 2009

Related U.S. Application Data
(63) Continuation-in-part of application No. 11/852,835, filed on Sep. 10, 2007, now Pat. No. 7,668,681.
Application No. 11/852,835 is a continuation-in-part of application No. 11/624,089, filed on Jan. 17, 2007, now Pat. No. 7,269,527.
(60) Provisional application No. 61/131,639, filed on Jun. 11, 2008.
(60) Provisional application No. 61/208,492, filed on Feb. 25, 2009.
(60) Provisional application No. 61/209,194, filed on Mar. 4, 2009.
(60) Provisional application No. 61/210,075, filed on Mar. 13, 2009.
(60) Provisional application No. 61/210,122, filed on Mar. 13, 2009.
(60) Provisional application No. 61/210,234, filed on Mar. 16, 2009.
(60) Provisional application No. 61/210,238, filed on Mar. 16, 2009.
(60) Provisional application No. 61/211,629, filed on Apr. 1, 2009.

(51) Int. Cl. G01T 3/00; G01T 1/17

(52) U.S. Cl. 250/390.01; 250/336.1

(57) ABSTRACT

A neutron detector includes a photo sensor with an electrical signal output electrically connected with an electrical signal input node of an electrical signal amplifier circuit. A resistive load is electrically connected between the electrical signal input node and a reference voltage node. The resistive load is a smaller resistance than an open circuit input resistance of the electrical signal amplifier circuit at the electrical signal input node thereby reducing the effective input resistance of the amplifier as seen by the photo sensor's electrical signal output. The neutron detector includes a set of scintillation layers connected to a light guide that channels light to the photo sensor. Moderator material is applied around the set of layers reducing thermal neutron absorption within the detector and increasing detector efficiency.

### CROSS-REFERENCE TO RELATED APPLICATIONS

This application is based upon and claims priority from prior co-pending provisional patent application No. 61/131/639, filed on Jun. 11, 2008, entitled “Method for Increased Scintillator Detector Performance”, and co-pending provisional patent application No. 61/208,492, filed Feb. 25, 2009, entitled “Method for Increased Gamma/Neutron Detector Performance”, and co-pending provisional patent application No. 61/209,194, filed Mar. 4, 2009, entitled “High Performance Neutron Detector with Near Zero Gamma Cross Talk”, and co-pending provisional patent application No. 61/210,075, filed Mar. 13, 2009, entitled “Method for Increased Gamma/Neutron Detector Performance”, and co-pending provisional patent application No. 61/210,122, filed Mar. 13, 2009, entitled “High Performance Neutron Detector with Near Zero Gamma Cross Talk (version 2)”, and co-pending provisional patent application No. 61/210,234, filed Mar. 16, 2009, entitled “High performance Neutron Detector with Near Zero Gamma Cross Talk (version 3)”, and co-pending provisional patent application No. 61/210,238, filed Mar. 16, 2009, entitled “Method of Passive Detection of Highly Enriched Uranium”, and co-pending provisional patent application No. 61/211,629, filed Apr. 1, 2009, entitled “Fabrication of a High Performance Neutron Detector with Near Zero Gamma Cross Talk”, and further this application is a continuation in part from co-pending U.S. patent application Ser. No. 11/852,835, filed on Sep. 10, 2007, entitled “Distributed Sensor Network With A Common Processing Platform For CBMRNE Devices And Novel Applications”, which is a continuation in part from previously co-pending U.S. patent application Ser. No. 11/624,089, filed on Jan. 17, 2007, entitled “System Integration Module For CBRNE Sensors”, now U.S. Pat. No. 7,269,527; the entire collective teachings thereof being herein incorporated by reference.

### FIELD OF THE INVENTION

The present invention generally relates to the field of gamma and neutron detection systems, and more particularly relates to high neutron detection efficiency with low gamma cross talk.

### BACKGROUND OF THE INVENTION

The accepted standard in neutron detection has been based on helium-3 (He3). One problem with conventional neutron detectors based on helium-3 is that helium-3 is a natural resource with a very limited supply. These types of detectors and all other known neutron detectors have a gamma rejection of approximately up to 4 gamma pulses in 10,000 pulses detected. Unfortunately, these levels of gamma rejection in conventional neutron detectors can result in too many false positive alarms, indicating that a neutron particle has been detected when in reality a gamma particle was detected. Gamma particles can occur from natural phenomena, such as from the sun, while neutron particles typically indicate a presence of radioactive and/or fissile material. Accurate detection of the occurrence of the neutron particles, without false detection of gamma particles as neutron particles, is critical for monitoring border activities such as during homeland defense and security.

The needs for homeland security, medical applications, military applications and others for an efficient neutron detector, with little to no false positive alarms, is critical.

Neutron detectors that are not based on helium-3 can generally use either lithium 6 or boron 10 dissolved uniformly into a plastic or glass scintillator. One problem with these types of detectors is that they produce much less light per event and require much more gain in a photomultiplier tube (PMT). These types of devices also have increased gamma ray sensitivity and use analog techniques to separate gamma from neutron events, which typically result in gamma pulse rejection rates of 4 in ten thousand, leaving an unsatisfactory rate of gamma false positives.

An example of a lithium 6 (6Li) neutron detector is described in U.S. Pat. No. 7,244,947 “Neutron detector with layered thermal-neutron scintillator and dual function light guide and thermalizing media” filed on Apr. 13, 2004 by Polichar and Baltgalvis and issued on Jul. 17, 2007. They describe a broad spectrum neutron detector with a thermal neutron sensitive scintillator film interleaved with a hydrogenous thermalizing media. In the Polichar invention, lithium 6 is combined with Zns (Ag) and a hydrogenous binder to form a thermalizing neutron detector layer. The neutrons collide with the scintillation layer to create light that is transported to a photo sensor. Moderator materials applied between the neutron detector layers thermalize the neutrons. The phosphor and fiber optics both act as efficient gamma detectors.

The 6LiZns(Ag) neutron detector described in U.S. Pat. No. 7,244,947 is described in detail in the attached Bicron Corporation and the Los Alamos National Laboratory (LANL) report published and released to the public in 2002: “Prototype Neutron-Capture Counter for Fast-Coincidence Assay of Plutonium in Residues”. The Bicron/LANL Team describes the use of 6LiZnS(Ag) mixture in a hydrogenous binder (moderator material) for each detector layer. Both Polichar and the Bicron/LANL Team acknowledge gamma interference that occurs with this type of detector and their need to find a method to separate the neutron and gamma signals. Pulse shape differentiation is discussed as a possible means to address the gamma interference, however, the analog pulse shape differentiation methods available were insufficient to correct the gamma interference. The neutron detection efficiencies, per layer, and the gamma interference rates described in the Polichar invention and the Bicron/LANL Team report require significant improvements to become a viable product that can compete with conventional neutron detector technologies such as the 3He neutron detector. In addition, the use of moderator materials within the 6LiZnS(Ag) detector mixture or between the 6LiAnS(Ag) detector layers causes a loss of thermal neutrons due to absorption by the moderator material reducing the number of available thermal neutrons for detection.

Furthermore, a thesis was published by Mr. Thomas McKnight describing the 6LiZnS(Ag) multi-layer detector using a hydrogenous binder. Again, the neutron detection efficiencies, per layer, and the gamma interference rates described in the McKnight thesis require significant improvements to become a viable product that can compete with conventional neutron detector technologies such as the 3He neutron detector. The McKnight design also uses moderator materials within the 6LiZnS(Ag) detector mixture reducing the number of thermal neutrons available for detection due to absorption by the thermalizing material. Pulse shape differentiation is discussed as a possible means to address the gamma interference, however, the analog pulse shape differentiation methods available were insufficient to correct the gamma interference.

Current attempts at the detection of special nuclear materials such as highly enriched uranium have difficulties with the low number of neutrons and the ability to shield low gamma energy that are generated from these materials. Those gamma detectors that can identify highly enriched uranium rely on low energy gamma below 200 Key, which can be easily shielded. Therefore, conventional detectors do not adequately detect special nuclear materials.

### SUMMARY OF THE INVENTION

In one embodiment, a neutron and/or gamma detector is disclosed. The neutron and/or gamma detector includes a photo sensor having an electrical signal output that includes a large series capacitive load. An electrical signal amplifier circuit has an electrical signal input node that is electrically coupled to the electrical signal output of the photo sensor. A resistive load has a first input node and a second output node. The first input node is electrically coupled to the electrical signal input node of the electrical signal amplifier circuit and the second output node is electrically coupled to a reference voltage node for the neutron and/or gamma sensor circuit. The resistive load is a substantially smaller resistance than an open circuit input resistance of the electrical signal amplifier circuit at the electrical signal input node. This reduces the input resistance of the electrical signal amplifier circuit at the electrical signal input node as seen by the photo sensor's electrical signal output that includes a large series capacitive load.

In another embodiment, a computer program product having stored therein a data structure for identifying one of a neutron pulse and a gamma pulse is disclosed. The data structure comprises at least a first data element representing a first pulse shape characteristic associated with a known pulse type being one of a neutron pulse type and a gamma pulse type. A second data element represents a second pulse shape characteristic that is different from the first pulse shape characteristic and that is associated with the known pulse type. The at least first data element and second data element are compared to the shape of at least one pulse signal received from at least one of a neutron detector and a gamma detector to identify the at least one pulse as one of a neutron pulse and a gamma pulse.

In yet another embodiment, a computer implemented method for identifying one of a neutron pulse and a gamma pulse is disclosed. The method includes receiving at least one pulse signal from at least one of a neutron detector and a gamma detector. A first pulse shape characteristic is received that is associated with a known pulse type being one of a neutron pulse type and a gamma pulse type. A second pulse shape characteristic is retrieved that is different from the first pulse shape characteristic, associated with the known pulse type. A shape of the least one pulse signal is compared to the first pulse shape characteristic and the second pulse shape characteristic. The at least one pulse signal is identified as one of a gamma pulse and a neutron pulse based on the comparing.

One or more embodiments of the present invention provide a high efficiency neutron detector using a scintillator medium coupled with fiber optic media that guide light and can operate at high signal speeds (e.g., unit nanosecond light pulse rates or faster) and performing analog to digital conversion at the front end. The gamma differentiation is performed through firmware in the digital electronics providing exceptional digital pulse shape discrimination for near zero gamma cross talk. Gamma rejection rates of up to 1 in ten million have been demonstrated.

According to one embodiment, a thermal neutron detector comprises one or more layers of 6LiF mixed in a binder medium with a scintillator material that are optically coupled to one or more fiber optic light guide media. These optical fibers have a tapered portion extending from one or both ends of said layers to guide the light to a narrowed section. The narrow section is coupled to a photo-sensor. A photo sensor is coupled to a pre-amp designed to drive the detector signal processing rate close to the decay time of the scintillator material. This enables pulses to be delivered without distortion to a set of electronics that performs analog to digital conversion. Firmware or software processes the signals to apply digital gamma pulse differentiation for elimination or separation of gamma signal interference from neutron detection.

In another embodiment, the moderator material for the thermal neutron detector system is designed around the thermal neutron detector, and moderator material is not used within the detector mixture or between the layers. This structure provides a designed level of moderator interaction with the neutrons before they are introduced to the thermal neutron detector. Each of the thermal neutron detector layers has an efficiency level for the detection of thermal neutrons. The multiple layers act to increase the detector efficiency. The elimination of moderator materials within the detector layers and/or between the detector layers reduces neutron absorption and increases the number of thermal neutrons available for detection.

In another embodiment, the moderator materials are designed and applied within the thermal neutron detector system to enable the differential detection of fast neutrons and thermal neutrons. The thermal neutron detector when exposed without moderator material is a simple thermal neutron detector. A thermal neutron detector surrounded by moderator material can be designed to detect fast neutrons within a thermal energy range due to the density and thickness of the moderator selected.

In another embodiment, the moderator material can be designed to enable the thermal neutron detector to detect fast neutrons thermalized to a specific energy range. Multiple layers of moderator and thermal neutron detectors can be arranged to detect different stages thermalized neutrons providing energy information on the neutrons detected at each layer.

In another embodiment, a method to fabricate a 6LiZnS(Ag) neutron detector is described. One of the benefits of this type of detector is that it can be formed into a wide variety of shapes and sizes including but not limited to a flat detector panel and a curved design where the detector can be configured for up to a 360 degree detector.

To fabricate a layer of the 6LiZnS(Ag) neutron detector, the 6Li isotope and the ZnS(Ag) phosphor materials are mixed in a ratio between 3:1 and 4:1. The 6LiZnS(Ag) is then mixed with a binder medium at between a 4:1 and 6:1 ratio. The scintillation layer have a thickness of about 0.1 mm to about 0.7 mm.

The neutron detector fabrication process is defined as the following steps.:
a. Optical fiber with a length being the length of the detector area and the additional lengths necessary to taper the fiber bundle to for the connection for the photo sensor.
b. The number of fiber optic strands are defined by the width of the detector area to be formed and the concentration of fiber optic strands to be equally spread across the width of the detector area.
c. The defined detector area is comprised of granular LiF (95% 6Li) mixed with crystals of ZnS(Ag) in a binder material. The LiF can be a greater concentration of 6Li.
d. A mold is produced with grooves designed to hold the optical fibers equally spaced across the detector material.
e. The detector materials and binder are mixed and formed into a detector area of a specific width and length, matching the design criteria for the fiber optics.
f. The detector mold is placed in a vacuum chamber for a period of time.
g. The detector mold is then baked in an oven for curing for a period of time.
h. Detector materials may be coupled to the top side of the optical fiber and to the bottom side of the optical fiber to form a sandwich design.
i. Multiple detector layers may be stacked together and connected to the same photo sensor.
j. The opposite ends of the fibers are cut, polished, and optically coupled to one or more photo sensors. The photo sensor may be applied on each end or only one end.
k. A protective covering is applied to the detector to eliminate light intrusion into the detector area.

According to one embodiment, staggered multiple layers of optical fiber strands and detector materials can be sandwiched together, where a first set of parallel fiber strands in a first fiber layer are disposed on top of the middle detector material layer and which is disposed on top of a second set of parallel fiber strands in a second fiber layer. The first set of parallel fiber strands is arranged in a staggered orientation relative to the second set of parallel fiber strands. By staggering the two sets of parallel fiber layers by a portion of the diameter of a fiber (such as by one half of the diameter of a fiber), it locates the sandwiched parallel fibers closer together (with the detector material in between) and thereby more likely to couple light photons into the fibers when neutrons interact with the detection materials.

A moderator material is designed to surround the thermal neutron detector. An optimum moderator design is applied to slow the fast neutrons to a thermal energy to enable the best efficiency for thermal neutron detection. An example of the moderator design is a two inch HPGE moderator material.

A protective covering is applied to the detector to eliminate light intrusion into the detector area. Thermistors may be applied to monitor the operating temperature of the detector components to enable automated or manual calibration of the detector output signals.

A light shield is applied to the outer shell of the detector layers to eliminate outside light interference by using an opaque shrink wrap as a light shield around the detector area up to and or covering a portion of the photo sensor. Another method for light shielding could be an opaque covering applied as a liquid that dries onto the detector and acts as a light shield around the detector area up to and or covering a portion of the photo sensor.

The neutron detector and the photo sensor are designed to be fabricated with precise alignment.

In another embodiment, a neutron and/or gamma sensor circuit comprises: a photo sensor having an electrical signal output that includes a series capacitive load; an electrical signal amplifier circuit having an electrical signal input node that is electrically coupled to the electrical signal output of the photo sensor; and a resistive load having a first input node and a second output node, the first input node being electrically coupled to the electrical signal input node of the electrical signal amplifier circuit and the second output node being electrically coupled to a reference voltage node for the neutron and/or gamma sensor circuit, the resistive load being a substantially smaller resistance than an open circuit input resistance of the electrical signal amplifier circuit at the electrical signal input node, thereby reducing the input resistance of the electrical signal amplifier circuit at the electrical signal input node as seen by the photo sensor's electrical signal output that includes a series capacitive load.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating an exemplary system according to one embodiment of the present invention;

FIG. 2 is block diagram of a neutron detector according to one embodiment of the present invention;

FIG. 3 is a schematic illustrating a neutron detector and its supporting components according to one embodiment of the present invention;

FIG. 4 is a circuit diagram for a pre-amp according to one embodiment of the present invention;

FIG. 5 is top-planar view of a neutron detector according to one embodiment of the present invention;

FIG. 6 is a graph illustrating a neutron pulse generated from a neutron detector according to one embodiment of the present invention;

FIG. 7 is a graph illustrating a gamma pulse generated from a neutron detector according to one embodiment of the present invention; and

FIG. 8 is a block diagram illustrating a detailed view of an information processing system according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and other similar terms as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Neutron Detector System

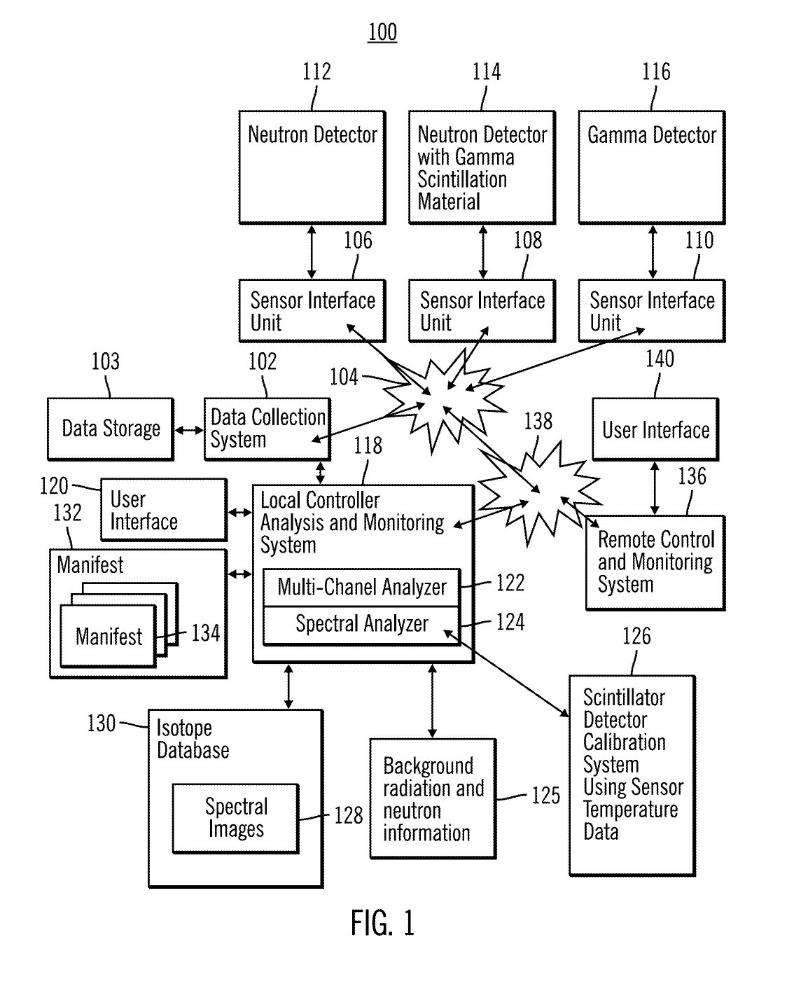

FIG. 1 is a block diagram illustrating one example of a neutron detector system 100 according to one embodiment of the present invention. In particular, FIG. 1 shows that a data collection system 102 is communicatively coupled via cabling, wireless communication link, and/or other communication links 104 with one or more high speed sensor interface units (SIU) 106, 108, 110. The high speed sensor interface units 106, 108, 110 each support one or more high speed scintillation detectors, which in one embodiment comprise a neutron detector 112, a neutron detector with gamma scintillation material 114, and a gamma detector 116. Each of the one or more SIUs 106, 108, 110 performs analog to digital conversion of the signals received from the high speed scintillation detectors 112, 114, 116. An SIU 106, 108, 110 performs digital pulse discrimination based on one or more of the following: pulse height, pulse rise-time, pulse fall-time, pulse-width, pulse peak, and pulse pile-up filter.

The data collection system 110, in one embodiment, includes an information processing system (not shown) comprising data communication interfaces (not shown) for interfacing with each of the one or more SIUs 124. The data collection system 110 is also communicatively coupled to a data storage unit 103 for storing the data received from the SIUs 106, 108, 110. The data communication interfaces collect signals from each of the one or more high speed scintillation detectors such as the neutron pulse device(s) 112, 114 and the gamma detector 116. The collected signals, in this example, represent detailed spectral data from each sensor device 112, 114, 116 that has detected radiation. In one embodiment, the SIU(s) 124 can discriminate between gamma pulses and neutron pulses in a neutron detector 112. The gamma pulses can be counted or discarded. Also, the SIU(s) 106, 108, 110 can discriminate between gamma pulses and neutron pulses in a neutron detector with gamma scintillation 114. The gamma pulses can be counted, processed for spectral information, or discarded.

The data collection system 102, in one embodiment, is modular in design and can be used specifically for radiation detection and identification, or for data collection for explosives and special materials detection and identification. The data collection system 102 is communicatively coupled with a local controller and monitor system 118. The local system 118 comprises an information processing system (not shown) that includes a computer system(s), memory, storage, and a user interface 120 such a display on a monitor and/or a keyboard, and/or other user input/output devices. In this embodiment, the local system 118 also includes a multi-channel analyzer 122 and a spectral analyzer 124.

The multi-channel analyzer (MCA) 122 can be deployed in the one or more SIUs 106, 108, 110 or as a separate unit 122 and comprises a device (not shown) composed of many single channel analyzers (SCA). The single channel analyzer interrogates analog signals received from the individual radiation detectors 112, 114, 116 and determines whether the specific energy range of the received signal is equal to the range identified by the single channel. If the energy received is within the SCA, the SCA counter is updated. Over time, the SCA counts are accumulated. At a specific time interval, a multi-channel analyzer 122 includes a number of SCA counts, which result in the creation of a histogram. The histogram represents the spectral image of the radiation that is present. The MCA 122, according to one example, uses analog to digital converters combined with computer memory that is equivalent to thousands of SCAs and counters and is dramatically more powerful and less expensive than deploying the same or even a lesser number of SCAs.

A scintillation calibration system 126 uses temperature references from a scintillation crystal to operate calibration measures for each of the one or more high speed scintillation detectors 112, 114, 116. These calibration measures can be adjustments to the voltage supplied to the high speed scintillation detector, adjustments to the high speed scintillation detector analog interface, and or software adjustments to the spectral data from the high speed scintillation detector 112, 114, 116. For example, high speed scintillator detector 112, 114, 116, can utilize a temperature sensor in contact with the scintillation crystal and/or both in the photo sensor of the detector to determine the specific operating temperature of the crystal. The specific operating temperature can be used as a reference to calibrate the high speed scintillation detector. The detector crystal and the photo sensor both may have impacts on detector signal calibration from changing temperatures. A temperature chamber can be used to track the calibration changes of an individual detector, photo sensor or mated pair across a range of temperatures. The calibration characteristics are then mapped and used as a reference against temperatures experienced in operation.

Histograms representing spectral images 128 are used by the spectral analysis system 124 to identify fissile materials or isotopes that are present in an area and/or object being monitored. One of the functions performed by the local controller 118 is spectral analysis, via the spectral analyzer 124, to identify the one or more isotopes, explosives, or special materials contained in a container under examination. In one embodiment, background radiation is gathered to enable background radiation subtraction. Background neutron activity is also gathered to enable background neutron subtraction. This can be performed using static background acquisition techniques and dynamic background acquisition techniques. Background subtraction is performed because there are gamma and neutron energies all around. These normally occurring gamma and neutrons can interfere with the detection of the presence of (and identifying) isotopes and nuclear materials. In addition, there can be additional materials other than the target giving off gammas and or neutrons. Therefore, the background gamma and neutron rate is identified and a subtraction of this background is performed to allow for an effective detection and identification of small amounts of radiation of nuclear material. This background and neutron information 125 is then passed to the local control analysis and monitoring system 118 so that precise and accurate monitoring can be performed without being hindered by background radiation. The dynamic background analysis technique used to perform background subtraction enables the neutron detector system 100 to operate at approximately 4 sigma producing an accuracy of detection above background noise of 99.999%.

After background subtraction, with respect to radiation detection, the spectral analyzer 124 compares one or more spectral images of the radiation present to known isotopes that are represented by one or more spectral images 128 stored in the isotope database 130. By capturing multiple variations of spectral data for each isotope there are numerous images that can be compared to one or more spectral images of the radiation present. The isotope database 130 holds the one or more spectral images 128 of each isotope to be identified. These multiple spectral images represent various levels of acquisition of spectral radiation data so isotopes can be compared and identified using various amounts of spectral data available from the one or more sensors. Whether there are small amounts (or large amounts) of data acquired from the sensor, the spectral analysis system 124 compares the acquired radiation data from the sensor to one or more spectral images for each isotope to be identified. This significantly enhances the reliability and efficiency of matching acquired spectral image data from the sensor to spectral image data of each possible isotope to be identified.

Once one or more possible isotopes are determined to be present in the radiation detected by the sensor(s) 112, 114, 116, the local controller 118 can compare the isotope mix against possible materials, goods, and/or products that may be present in the container under examination. Additionally, a manifest database 132 includes a detailed description (e.g., manifests 134) of the contents of a container that is to be examined. The manifest 134 can be referred to by the local controller 118 to determine whether the possible materials, goods, and/or products, contained in the container match the expected authorized materials, goods, and/or products, described in the manifest for the particular container under examination. This matching process, according to one embodiment of the present invention, is significantly more efficient and reliable than any container contents monitoring process in the past.

The spectral analysis system 124, according to one embodiment, includes an information processing system (not shown) and software that analyzes the data collected and identifies the isotopes that are present. The spectral analysis software is able to utilize more than one method to provide multi-confirmation of the isotopes identified. Should more than one isotope be present, the system 124 identifies the ratio of each isotope present. There are many industry examples of methods that can be used for spectral analysis for fissile material detection and isotope identification.

The data collection system 102 can also be communicatively coupled with a remote control and monitoring system 136 via at least one network 138. The remote system 136 comprises at least one information processing system (not shown) that has a computer, memory, storage, and a user interface 140 such as a display on a monitor and a keyboard, or other user input/output device. The networks 104, 138 can be the same networks, comprise any number of local area networks and/or wide area networks. The networks 104, 138 can include wired and/or wireless communication networks. The user interface 140 allows remotely located service or supervisory personnel to operate the local system 118; to monitor the status of shipping container verification by the collection of sensor units 106, 108, 110 deployed on the frame structure; and perform the operations/functions discussed above from a remote location.

Neutron Detector

The following is a more detailed discussion of a neutron detector such as the neutron detector 112 or 114 of FIG. 1. The neutron detector of various embodiments of the present invention provides high levels of efficiency with near zero gamma cross talk. The neutron detector is a high efficiency neutron detector that uses a scintillator medium coupled with fiber optic light guides with high speed analog to digital conversion and digital electronics providing digital pulse shape discrimination for near zero gamma cross talk.

The neutron detector of various embodiments of the present invention is important to a wide variety of applications: such as portal detectors, e.g., devices in which a person or object is passed through for neutron and gamma detection, fissile material location devices, neutron based imaging systems, hand held, mobile and fixed deployments for neutron detectors. The neutron detector in various embodiments of the present invention, for example, can utilize the Systems Integration Module for CBRNE sensors discussed in the commonly owned U.S. Pat. No. 7,269,527, which is incorporated by reference herein in its entirety.

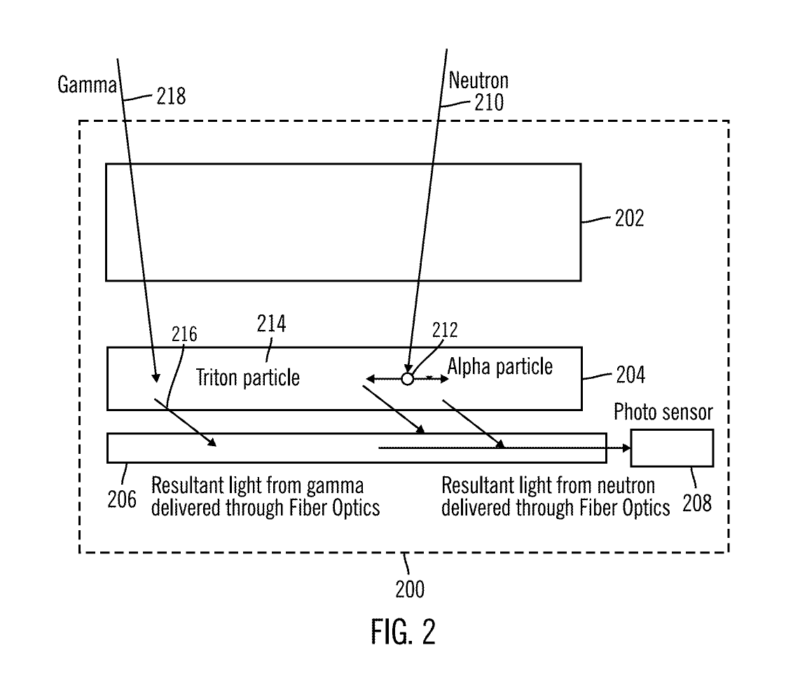

FIG. 2 is a block diagram illustrating a more detailed view of a neutron detector 200 according to one embodiment of the present. In particular, FIG. 2 shows that the neutron detector 200 comprises a neutron moderator material 202 such as polyethylene and scintillation material 204 which can comprise, in this example, 6Li of 6LiF or any similar substance. In one embodiment, the 6LiF is mixed in a hydrogenous binder medium with a scintillator material 204 and has a thickness of about (but not limited to) 0.1 mm to about 0.5 mm. The scintillator material 204, in one embodiment can comprise one or more materials such as (but not limited to) ZnS, ZnS(Ag), or NaI(Tl). One or more of these materials give the neutron detector 200 resolution for gamma signals that can be used in spectroscope analysis.

The moderator material 202 acts as a protective layer that does not allow light into the detector 200. Alternatively, a separate light shield can be applied to the outer shell of the detector layers to eliminate outside light interference. Also, the moderator material 202 can comprise interposing plastic layers that act as wavelength shifters. According to one embodiment, at least one plastic layer is adjacent to (and optionally contacting) the at least one light guide medium. According to one embodiment, the at least one light guide medium at the at least one scintillator layer is substantially surrounded by plastic that acts as a wavelength shifter. That is, the plastic layers (and/or optionally plastic substantially surrounding the light guide medium at the at least one scintillator layer) act(s) as wavelength shifter(s) that receive light photons emitted from the at least one scintillator layer (from neutron particles interacting with the at least one scintillator layer) and couple these photons into the at least one light guide medium. According to one embodiment, the at least one light guide medium at the at least one scintillator layer comprises fiber optic media that acts as a wavelength shifter (e.g., wave shifting fiber). This provides a more efficient means of collecting light out the end of the at least one light guide medium, such as when the light enters from substantially normal incidence from the outside of the at least one light guide medium.

An example of a moderator material that can be used with the present invention comprises dense polyethylene. The optimum moderator configuration, in one embodiment, is estimated at 2 inches of dense polyethylene. The moderator material 202 thermalizes the fast neutrons before they enter the detector 200. This thermalization of the fast neutrons allows the thermal neutron detector to perform at an optimum efficiency. Thermal neutron sensitive scintillator material that is useful in the fabrication of a neutron detector such as the detector 200 of FIG. 2 includes, but is not limited to 6Li—ZnS, 10BN, and other thin layers of materials that release high energy He or H particles in neutron capture reactions. Such materials can be 6Li- or 10B-enriched ZnS, 10BN, or other phosphors that contain Li or B as an additive. Examples of such scintillator plastics include BC 480, BC 482, and BC 484, all available from the French company St. Gobain, SA.

The neutron detector 200 also comprises a light carrying medium 206 such as fiber optics that is coupled to a photo sensor 208. The photo sensor 508, in one embodiment, comprises a photomultiplier tube or an avalanche diode. The 6Li or 6LiF and scintillator material 204 is optically coupled to the light guide medium 206. The light guide medium 206, in one embodiment, includes a tapered portion that extends from one or both ends of the scintillation layer 204 to guide the light to a narrowed section. This narrowed section is optically coupled to the photo sensor 208 at the tapered portion. The photo sensor, such as the photomultiplier tube, is tuned to operate close to the light frequency of the light photons generated from the scintillation material and carried by the light guide medium.

The scintillation material 204 is excited by an incident neutron 210 that is slowed by the moderator material 202. The incident material reacts by emitting an alpha particle 212 and triton 214 into the neighboring scintillation material 204, which can be, in this example, a phosphor material. The scintillation material 204 is energized by this interaction and releases the energy as photons (light) 216. The photons 216 travel into the light carrying medium 206 and are guided to the ends of the medium 206 and exit into the photo sensor 208. In one embodiment, the light guide medium 206 is a wavelength shifter. The wavelength shifter shifts blue or UV light to a wavelength that matches the sensitivity of a photo sensor 208, avalanche sensor, or diode sensor. It should be noted that a gamma particle 218 can also hit the scintillation material 204, which creates photons 216 that are received by the photo sensor 208.

The neutron detector 200 provides significant improvements in form and function over a helium-3 neutron detector. The neutron detector 200 is able to be shaped into a desired form. For example, the scintillator layer(s) and moderator material can be curved and configured for up to a 360 degree effective detection angle of incidence. The at least one scintillator layer and moderator material can be flat and designed as a detector panel. The neutron detector 200 comprises a uniform efficiency across the detector area. The neutron detector 200 can comprise multiple layers to create an efficiency which is substantially close to 100%.

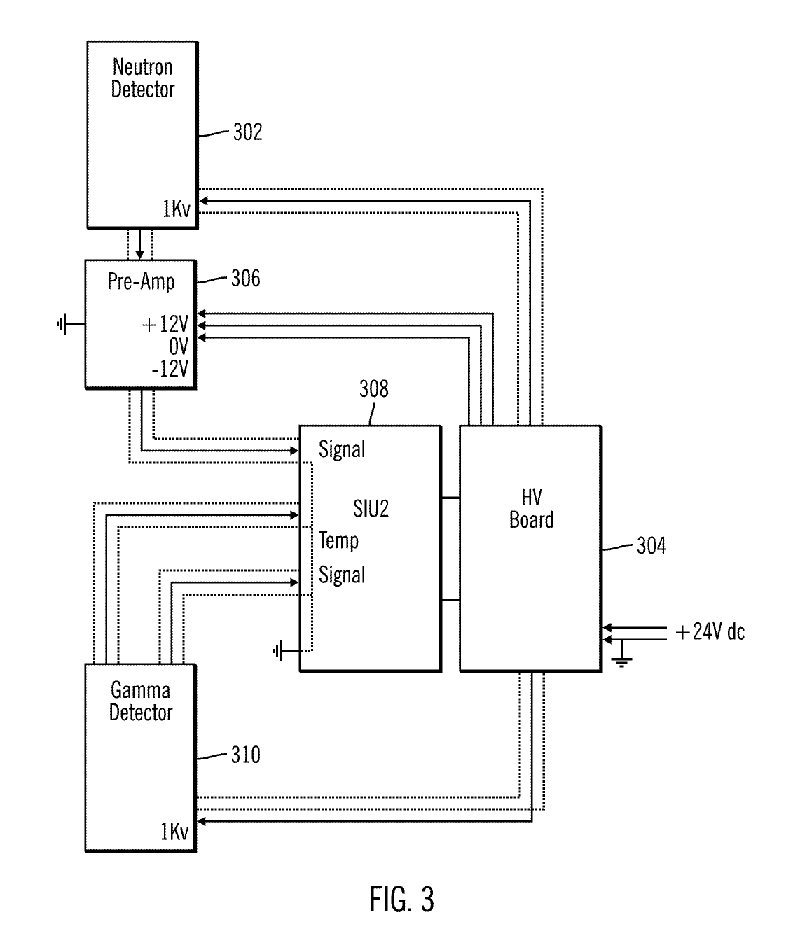

FIG. 3 is a schematic that illustrates various components that are used to support a neutron detector such as the neutron detectors 112, 114 shown in FIG. 1. In one embodiment, the various electrical components shown in FIG. 3 provide a signal sampling rate of 50 million samples per second or faster. In particular, FIG. 3 shows a neutron detector 302 electrically coupled to a high voltage board 304, which provides power to the neutron detector 302. The neutron detector 302 generates analog signals that are received by a pre-amp component 306, which is also electrically coupled to the high voltage board 304. The pre-amp 306, in one embodiment, drives the detector signal processing rate close to the decay time of the scintillator material in the detector 302. This enables pulses to be delivered without distortion to a set of electronics that perform analog to digital conversion, such as the SIU 308. The SIU 308 is electrically coupled to the pre-amp 306, high voltage board 304, and a gamma detector 310 (in this embodiment). The analog signals from the neutron detector 302 are processed by the pre-amp 306 and sent to the SIU unit 308. The SIU 308 performs an analog-to-digital conversion process on the neutron detector signals received from the pre-amp 306 and also performs additional processing, which has been discussed above.

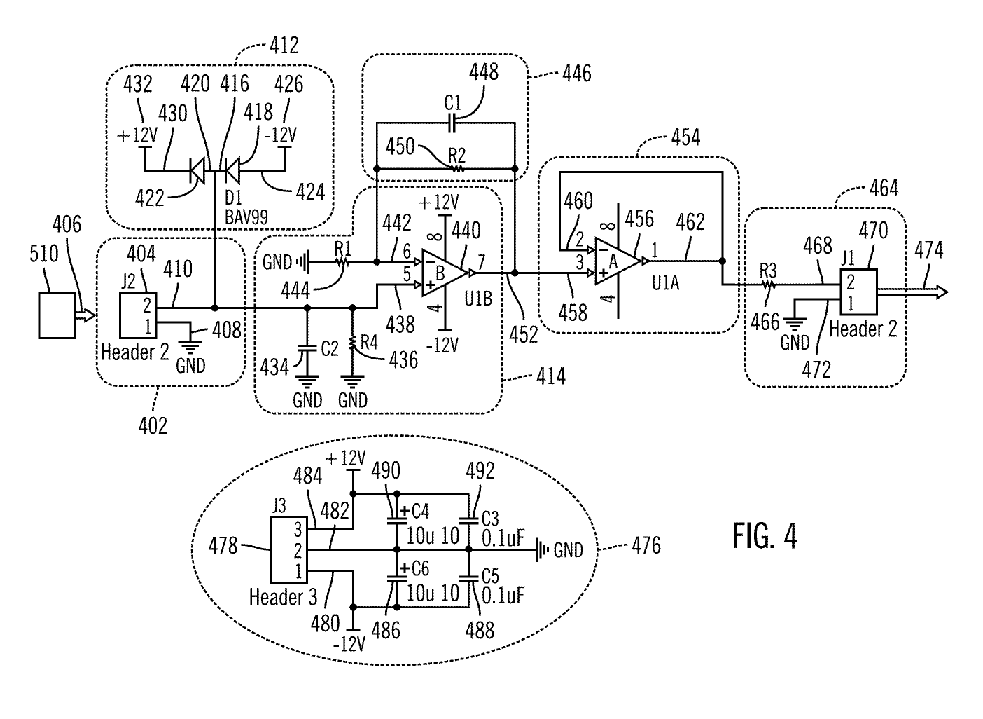

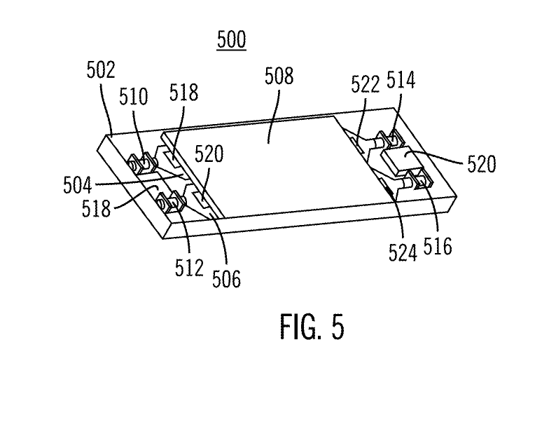

FIG. 4 shows a more detailed schematic of the pre-amp component 306. The pre-amp component 306 shown in FIGS. 3 and 4 is enhanced to reduce the pulse stretching and distortion typically occurring with commercial preamps. The pre-amp 306 of FIGS. 3 and 4 removes any decay time constant introduced by capacitive and or inductive effects on the amplifier circuit. For example, the impedance, in one embodiment, is lowered on the input of the preamp that is attached to the output of a photomultiplier tube 510, 512, 514, 516 (FIG. 5) to maintain the integrity of the pulse shape and with the preamp output signal gain raised to strengthen the signal.

The pre-amp circuit 306 of FIG. 4 includes a first node 402 comprising a header block 404 that is electrically coupled to the output 406 of the neutron detector photomultiplier 510 as shown in FIG. 4. A first output 408 of the header block 404 is electrically coupled to ground, while a second output 410 of the header block 404 is electrically coupled a second node 412 and a third node 414. In particular, the second output 410 of the header block 404 is electrically coupled to an output 416 of a first diode 418 in the second node 412 and an input 420 of a second diode 422. The input 424 of the first diode 418 is electrically coupled to a voltage source 426. The output of the first diode is electrically coupled to the input of the second diode. The output 440 of the second diode 422 is electrically coupled to a second voltage source 442.

The third node 414 comprises a capacitor 444 electrically coupled to ground and a resistor 436 that is also electrically coupled to ground. The capacitor 444 and the resistor 436 are electrically coupled to the second output 410 of the header block 406 and to a first input 438 of an amplifier 440. A second input 442 of the amplifier 440 is electrically coupled to a resistor 444 to ground. The amplifier 440 is also electrically coupled to a power source as well. A fourth node 446 is electrically coupled to the second input 442 of the amplifier in the third node 414. The fourth node 446 includes a capacitor 448 and a resistor 450 electrically coupled in parallel, where each of the capacitor 448 and resistor 450 is electrically coupled to the second input 442 of the amplifier 440 in the third node 414 and the output 452 of the amplifier 440 in the third node 414.

The output 452 of the amplifier 440 in the third node 414 is electrically coupled to a fifth node 454 comprising another amplifier 456. In particular, the output 452 of the amplifier 440 of the third node 414 is electrically coupled to a first input 458 of the amplifier 456 in the fifth node 454. A second output 460 of the amplifier 456 in the fifth node 454 is electrically coupled to the output 462 of the amplifier 456. The output 462 of the amplifier 456 is electrically coupled to a sixth node 464. In particular, the output 462 of the amplifier 456 in the fifth node 454 is electrically coupled to a resistor 466 in the sixth node 464, which is electrically coupled to a first input 468 of another header block 470. A second input 472 of the header block 470 is electrically coupled to ground. An output 474 of the header block 470 is electrically coupled to an analog-to-digital converter such as an SIU discussed above.

The pre-amp circuit 306 of FIG. 4 also includes a seventh node 476 comprising a header block 478. A first 480 and third 484 output of the third header block 478 is electrically coupled to a respective voltage source. A second output 482 is electrically coupled to ground. The first output 480 is electrically coupled to a first 486 and second 488 capacitor, which are electrically coupled to the second output 482. The third output 484 is electrically coupled to a third 490 and a fourth 492 capacitor, that are electrically coupled to the second output 482 as well.

FIG. 5 shows a top planar cross-sectional view of a neutron detector component 500 that can be implemented in the system of FIG. 1. In particular, FIG. 5 shows a housing 502 comprising one or more thermal neutron detectors 504, 506. The thermal neutron detector 504, 506, in this embodiment, is wrapped in a moderator material 508. Photomultiplier tubes 510, 512, 514, 516 are situated on the outer ends of the thermal neutron detectors 504, 506. Each of the photomultiplier tubes 510, 512, 515, 516 is coupled to a preamp 518, 520, 542, 544. Each preamp 518, 520, 522, 524 is electrically coupled to a sensor interface unit 556, 528. Each preamp 518 can be electrically coupled to its own SIU 526, 528 or to an SIU 526, 528 that is common to another preamp 520, as shown in FIG. 5.

The thermal neutron detector 504, 506 is wrapped in a moderator material 508 comprising moderator efficiencies that present a greater number of thermalized neutrons to the detector 504, 506 as compared to conventional neutron detectors. A neutron moderator is a medium that reduces the speed of fast neutrons, thereby turning fast neutrons into thermal neutrons that are capable of sustaining a nuclear chain reaction involving, for example, uranium-235. Commonly used moderators include regular (light) water (currently used in about 75% of the world's nuclear reactors), solid graphite (currently used in about 20% of nuclear reactors), and heavy water (currently used in about 5% of reactors). Beryllium has also been used in some experimental types, and hydrocarbons have been suggested as another possibility.

The following is a non-exhaustive list of moderator materials that are applicable to one or more embodiments of the present invention. Hydrogen, as in ordinary water (“light water”), in light water reactors. The reactors require enriched uranium to operate. There are also proposals to use the compound formed by the chemical reaction of metallic uranium and hydrogen (uranium hydride—UH₃) as a combination fuel and moderator in a new type of reactor. Hydrogen is also used in the form of cryogenic liquid methane and sometimes liquid hydrogen as a cold neutron source in some research reactors: yielding a Maxwell-Boltzmann distribution for the neutrons whose maximum is shifted to much lower energies. Deuterium, in the form of heavy water, in heavy water reactors, e.g. CANDU. Reactors moderated with heavy water can use unenriched natural uranium. Carbon, in the form of reactor-grade graphite or pyrolytic carbon, used in e.g. RBMK and pebble-bed reactors, or in compounds, e.g. carbon dioxide. Lower-temperature reactors are susceptible to buildup of Wigner energy in the material. Like deuterium-moderated reactors, some of these reactors can use unenriched natural uranium. Graphite is also deliberately allowed to be heated to around 2000 K or higher in some research reactors to produce a hot neutron source: giving a Maxwell-Boltzmann distribution whose maximum is spread out to generate higher energy neutrons. Beryllium, in the form of metal, is typically expensive and toxic, and so its use is limited. Lithium-7, in the form of a fluoride salt, typically in conjunction with beryllium fluoride salt (FLiBe) is the most common type of moderator in a Molten Salt Reactor. Other light-nuclei materials are unsuitable for various reasons. Helium is a gas and is not possible to achieve its sufficient density, lithium-6 and boron absorb neutrons.

In addition to the neutron detector configuration shown in FIG. 5, a multi-layered neutron detector can also be used in one or more embodiments of the present invention. In this embodiment a full neutron detector is constructed with moderator material and multiple layers of the neutron detector device. A second full neutron detector with moderator material is positioned directly behind the first to create a multilayered neutron detector system. In another embodiment, moderator materials are interleaved between one or more of the detector layers. Additional moderator materials may be applied surrounding this detector configuration.

Also, one or more embodiments of the present invention can be utilized as a passive neutron detection system for shielded nuclear materials such as highly enriched uranium. In this embodiment, the neutron detector discussed above provides strong detection capabilities for shielded nuclear material. Additional detector configurations may be added to increase the shielded nuclear materials detection capability. The thermal neutron detector system 100 may also add one or more fast neutron detectors designed as a high performance detector with modified preamp and connection to the sensor interface unit for high speed digital data analysis. The sandwich neutron detector design discussed above can be used to increase the detection capability of shielded nuclear materials. A more efficient moderator material may be developed to increase the number of fast neutrons that are thermalized and presented to the neutron detector. Also, the neutron detector of the various embodiments of the present invention can use moderator materials for a portion of the detector surface area to enable detection of thermal neutrons and to convert fast neutrons to thermal neutrons.

Experimental Information

Based on the processing speeds and features of the proprietary sensor interface unit (SIU) 106, 108, 100, (which is commercially available from Innovative American Technologies, Inc.) experiments were performed with gamma/neutron pulse differentiation techniques. The various embodiments of the present invention were able to effectively eliminate the gamma detections without impacting the neutron detection efficiencies. After extensive testing, it was found that the conventional multichannel analyzers and detector electronics in the industry with primarily applied features on the analog side of the electronics ran at slower speeds than the neutron detector pulse. The pulses were subsequently altered (slowed down) to address the slower MCA electronics. Slowing the pulse distorts the shape of the pulse, which causes problems in differentiating between gamma and neutron pulses. Also, when the electronics extend the pulse, an opportunity is created for pulse stacking to occur, where the overall envelope is larger than that of a single neutron pulse, rendering the pulse shape analysis unreliable at best.

Therefore, the neutron pre-amp 306 (FIG. 3) according to one or more embodiments of the present invention is enhanced to reduce the pulse stretching and distortion typically occurring with commercial pre-amps. That is, the pre-amp circuit is configured to operate substantially close to a decay time of the scintillator layer when interacting with neutrons, and without adding further extension (distortion) to the electrical signal output from the pre-amp. The pre-amp 306 removes decay time constant that may be introduced by capacitive and or inductive effects on the amplifier circuit. For example, the impedance can be lowered on the input of the pre-amp attached to the output from the photomultiplier tube to maintain the integrity of the pulse shape, and optionally with the pre-amp output gain raised to strengthen the output signal.

The neutron detector 200 improves the gamma discrimination by utilizing the preamp 306 to keep the pulse as close as possible to its original duration and shape with a pulse duration of approximately 250 nanoseconds (in one embodiment). This improves linearity and increases the ability to process more counts per second, especially in a random burst where multiple gamma and/or neutron pulse events may be blurred into one pulse. The programmable gain and offset of the SIU 106, 108, 110 analog front end presents the pulse signal to a 50 MHz high speed/high resolution digitizer which feeds the Field programmable Gate Array (FPGA) that includes proprietary hardware real-time Pulse DSP programmable filters from Innovative American Technology (IAT), Inc. The high speed analog-to-digital conversion circuit (within the SIUs) can plot the fastest pulse with approximately 15 points of high resolution data. These programmable filters are used in the second stage of signal processing to eliminate noise and most gamma pulses via a LLD (low level discriminator) or noise canceller as well as employing a pulse rise time filter. Pulses must meet a minimum rise time to be considered for analysis. The next stage of signal processing occurs at a pulse width filter, which measures the duration of the pulse at a point where the shape widens when the pulse originates from a neutron reaction. Gamma pulses have a clean and rapid decay, whereas neutron interaction with the detector produces an extended fall time.

The result of the above signal processing is that the speed of the SIU 106, 108, 110 system hardware and embedded processor clearly differentiates between a neutron pulse and a gamma pulse. This enables the neutron detector system 100 to eliminate nearly 100% of the gamma pulses received by the neutron detector without impacting the neutron detector efficiencies. Subsequent testing at various laboratories supported zero gamma detection (zero gamma cross-talk) under high gamma count rates and high gamma energy levels. For example, testing with Cs137 in the inventor's lab (16micro-curies) placed directly in front of the neutron detector, using the IAT commercially available SIU and RTIS application components, provided the following results: 1/10,000,000 (one in ten million) gamma pulse counts using Cs137 for the test. The neutron detector 200 was deployed using the IAT detection, background subtraction and spectral analysis system software operating at 4.2649 sigma which translates to a false positive rate of 1/100,000 (one in one hundred thousand) or an accuracy rate of 99.999%.

An Example of a Discrimination Process

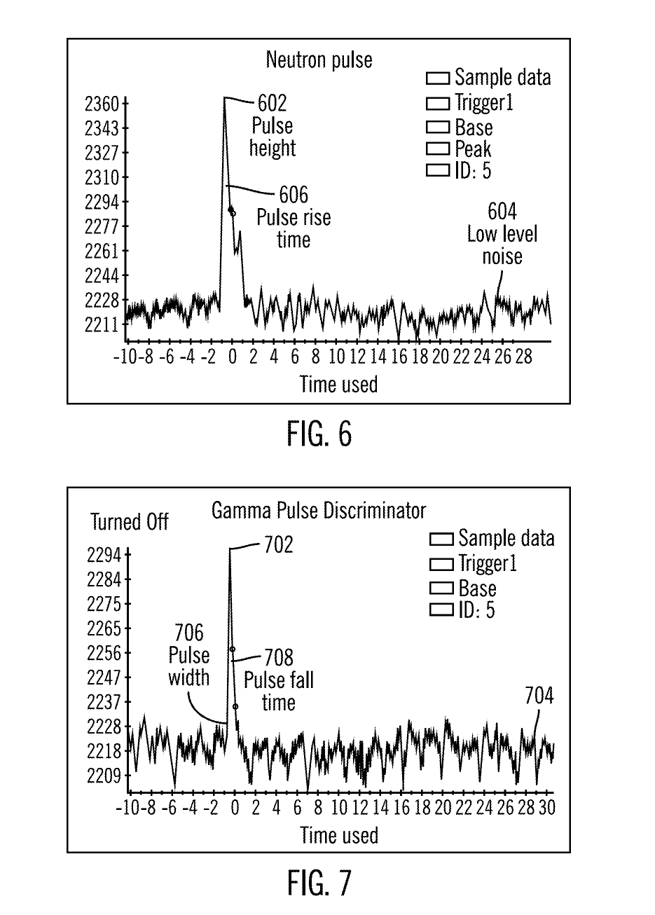

FIGS. 6 and 7 show a neutron pulse and a separate gamma pulse, respectively, generated from the neutron detector 200 and digitally converted for processing. The neutron pulse in FIG. 6 represents a pure pulse without distortion, meets the pulse height 602 requirements, is above the noise threshold filter 604, meets the pulse rise-time requirements 604, and has a much wider base than the example gamma pulse in FIG. 7, accordingly identifying the pulse as a neutron pulse. The gamma pulse in FIG. 7, meets the pulse height requirement, is above the noise threshold filter, does not meet the pulse rise width 702 requirement, and is therefore eliminated through pulse shape discrimination (which comprise discrimination by any one or more of the following signal features: pulse height, pulse width, pulse rise time, and/or pulse fall time).

Therefore, the neutron detector 200 provides various improvements over conventional helium-e type detectors. For example, with respect to the neutron detector 200, the pulse height allows the detector system 100 to provide better discrimination against lower energy gamma. The Li+n reaction in the neutron detector 200 produces 4.78 Mev pulse. The He3+n reaction only produces 0.764 Mev pulse. With respect to wall effects, the neutron detector 200 is thin so a very small fraction of the gamma energy is absorbed making very small gamma pulses. Pile up of pulses can produce a larger apparent pulse. However this is avoided with the fast electronics. The walls of the He3 detectors capture some energy, which broadens the pulse. Thus, such implementation typically uses large size tubes. With a broad neutron pulse fast electronics cannot be used to discriminate against gamma pulses during pile up without cutting out some of the neutron pulse energy.

With respect to pulse width, the neutron pulse width is narrower in the neutron detector 200 than in He3 detectors. This makes the use of fast electronics more beneficial. With respect to, thermal neutron efficiency He3 is very efficient 90% at 0.025 eV neutrons. However He3 efficiency drops off rapidly to 4% for 100 ev neutrons. Because He3 is a gas a large volume detector is needed to get this efficiency. He3 efficiency coupled with a moderator assembly is estimated at between 30% down to 1% across the energy range and depends on He3 volume. The neutron detector 200 is a solid material, and smaller volumes can be used. Multiple layers of the neutron detector 200 raise the overall detector system efficiency. In one embodiment of the present invention, a four layer configuration of the neutron detector 200 was constructed that reached efficiencies of close to 100%. The neutron detector 200 efficiency coupled with the moderator assembly is estimated at 30% across the energy range.

The neutron detector 200 is advantageous over conventional helium-3 neutron detectors for the following reasons. The neutron detector can be shaped into any desired form. The neutron detector comprises uniform efficiency across the detector area. Also, multiple layers of the detector can create an efficiency which is close to 100%.

Detection of Shielded HEU (Passively)

The neutron detector 200, in one embodiment, is an effective passive detector of specialized nuclear materials. The most difficult to detect is typically highly enriched uranium (HEU). More difficult is shielded highly enriched uranium. The HEU detection capabilities were analyzed and the conclusions are discussed below. The useful radioactive emissions for passively detecting shielded HEU are neutron and gamma rays at 1 MeV from decay of U-238. The neutrons offer the best detection option. The gamma rays with energy below 200 KeV are practical for detecting only unshielded HEU since these are too easily attenuated with shielding. The most effective detection solutions will place detectors with the largest possible area and most energy-specificity within five meters and for as long a time as possible since: (a.) at distances of 10 meters or more, the solid angle subtended by the detector (˜detector area/distance2) from a 50 kg HEU source is likely to reduce the signal as much as any reasonable size shielding, and (b) with sufficient time for the detector to detect neutron counts and photon counts within a narrow enough photon energy range, even signals below the background can be detected.

In one model applicable to one or more embodiments of the present invention, it is assumed that the HEU core is shielded externally by lead. The linear attenuation coefficient, defined as the probability per unit distance that a gamma ray is scattered by a material, is a function of both the material and the energy of the gamma ray. Steel and concrete have linear attenuation coefficients at 1 MeV that are not all that different from lead, so the conclusions will be roughly similar even with other typical shielding materials. In addition to the external shield, the mass of HEU itself acts to shield gamma rays (self-shielding). The number of neutrons and gamma rays that reach the detector is limited by the solid angle subtended by the detector from the source. Finally, detection involves reading enough counts of neutrons and gamma rays to be able to ascertain a significant deviation from the background and the detector only detects a fraction of those neutron and gamma rays that are emitted due to detection inefficiencies. Each of these factors when put together forms a “link budget” and is explained below.

Nuclear theory is used to estimate the maximum distance possible for passive detection of a lead-shielded HEU spherical core using both U-238 and U-232 signals. The distance compared against variables of interest including detector area, detection time, shield thickness, and mass of the HEU core. Detection distance depends on amount of HEU and its surface area, shielding, detector area, distance, and time available to detect the emissions. Maximum detection distance is dependent on these factors. The neutron emissions and the neutron detector 200 are used, in this example, to enable neutron detection to four counts above background noise levels. The low number neutron counts and the low number 1 MeV gamma counts are used to identify the source as a high probability of shielded HEU.

The neutron “link budget” is not easily amenable to analytical approximation as it is for gammas. For a comparison with gammas, the basics of neutron emissions and attenuation are presented here in the specific case of weapons grade Uranium (WgU). Weapons grade Uranium (WgU) emits neutrons at the rate of roughly 1/s/kg with an energy distribution centered around 1 MeV—primarily due to spontaneous fission of Uranium isotopes, with each of 234, 235, and 238 contributing roughly equal numbers of neutrons given their relative composition in WgU. These energetic neutrons also have mean free path lengths of 2-6 cm in most shielding materials (tungsten, lead, etc.) whereas 1 MeV gammas are only ˜1 cm by comparison. A 24 kg WgU sample with tungsten tamper emits 60 neutrons per second in addition to 60 1 MeV gamma rays per second at the surface of the sample. The path loss through free space is equivalent for both forms of radiation. Although neutrons may pass through shielding further than 1 MeV gammas, the difference is small enough that detection of shielded HEU using neutrons and the identification of shielded HEU through the combined detection of low counts for both neutrons and 1 MeV gamma is viable.

Gamma Emissions of U-238, U-235, and U-232

Uranium consists of multiple isotopes. By definition highly enriched Uranium (HEU) has more than 20% 13 of the isotope U-235 which is fissile, and weapons grade Uranium contains over 90%14 U-235. Radioactive decay of U-235 results in gamma rays at 185 KeV, but shielding too easily attenuates these and so they are not useful for detecting shielded HEU. HEU also contains the isotope U-238—the more highly enriched, the less the percentage of U-238. A conservative assumption for detection using U-238 emissions is that HEU or weapons grade Uranium contains at least 5% U-238 by weight. U-232 may also be present in trace quantities (parts per trillion).

U-238 emits 81 gammas per second per gram at 1.001 MeV. This number can also be derived using first principles and nuclear data, but results in only a slightly higher value based on data from U-232's decay chain produces even more penetrating gamma rays than U-238. The most important gamma emitter in the U-232 decay chain is T1-208, which emits a 2.6 MeV gamma ray when it decays. These gamma rays can be effectively used to detect the presence of HEU if U-232 is known to be a contaminant, even to the effect of a few hundred parts per trillion. Embodiments of the present invention can similarly arrive at the rates for U-232, the most penetrating of which has emissions at 2.614 MeV at a rate of 2.68×1011 gammas per gram per second.

In an analysis of the neutron detector system 100 it was determined that the ability to create a large neutron detector surface area with enhanced performance through modifications to the conventional preamp, use of digital electronics described in the sensor interface unit, advanced background subtraction methods and advanced spectral analysis methods, the system 100 was able to detect and identify special nuclear materials such as highly enriched uranium and shielded highly enriched uranium at quantities below 24 kilograms through a combination of neutron and gamma detections.

The passive scintillation detector system discussed above can be configured to detect and identify shielded highly enriched uranium based on low neutron counts coupled with low 1 MeV gamma counts. The system detects and identifies highly enriched uranium based on low level neutron counts coupled with low gamma counts at 1 MeV or greater energies coupled with gamma ray energy associated with HUE that are below 200 KeV.

The passive scintillation detector system discussed above can also be configured as a horizontal portal, a truck or bomb cart chassis, a spreader bar of a gantry crane, a straddle carrier, a rubber tired gantry crane, a rail mounted gantry crane, container movement equipment, a truck, a car, a boat, a helicopter, a plane or any other obvious position for the inspection and verification of persons, vehicles, or cargo. The system can be configured for military operations or military vehicles, and for personal detector systems. The system can also be configured for surveillance and detection in protection of metropolitan areas, buildings, military operations, critical infrastructure such as airports, train stations, subway systems or deployed on a mobile platform such as a boat, a vehicle, a plane, an unmanned vehicle or a remote control vehicle.

Information Processing System

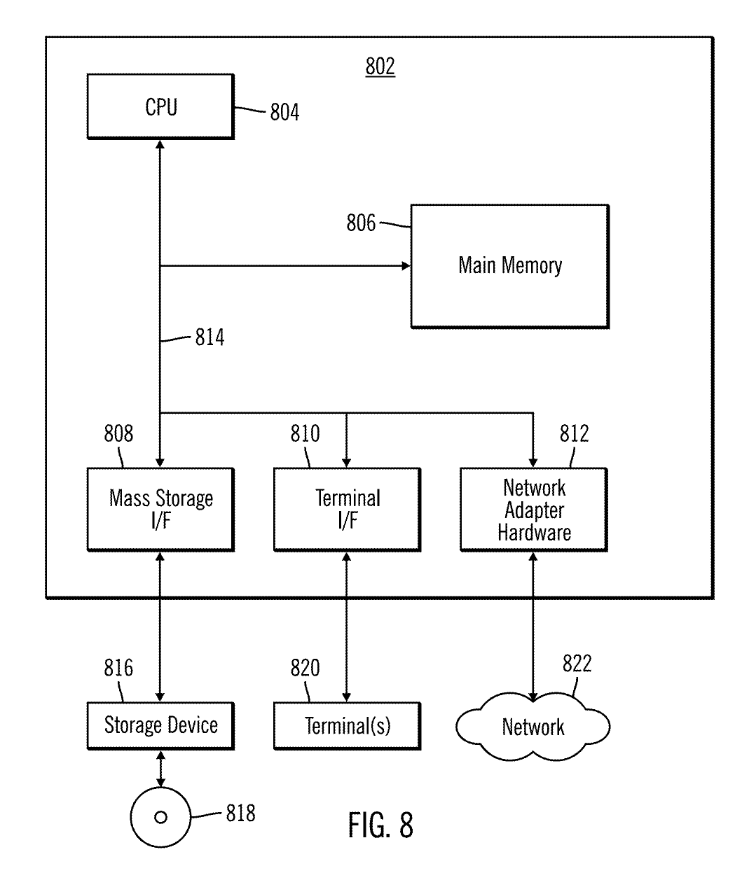

FIG. 8 is a block diagram illustrating a more detailed view of an information processing system 800 according to one embodiment of the present invention. The information processing system 800 is based upon a suitably configured processing system adapted to be implemented in the neutron detection system 100 of FIG. 1. Any suitably configured processing system is similarly able to be used as the information processing system 800 by embodiments of the present invention such as an information processing system residing in the computing environment of FIG. 1, a personal computer, workstation, or the like.

The information processing system 800 includes a computer 802. The computer 802 has a processor(s) 804 that is connected to a main memory 806, mass storage interface 808, terminal interface 810, and network adapter hardware 812. A system bus 814 interconnects these system components. The mass storage interface 808 is used to connect mass storage devices, such as data storage device 816, to the information processing system 800. One specific type of data storage device is an optical drive such as a CD/DVD drive, which may be used to store data to and read data from a computer readable medium or storage product such as (but not limited to) a CD/DVD 818. Another type of data storage device is a data storage device configured to support, for example, NTFS type file system operations.

In one embodiment, the information processing system 800 utilizes conventional virtual addressing mechanisms to allow programs to behave as if they have access to a large, single storage entity, referred to herein as a computer system memory, instead of access to multiple, smaller storage entities such as the main memory 806 and data storage device 816. Note that the term “computer system memory” is used herein to generically refer to the entire virtual memory of the information processing system 800.

Although only one CPU 804 is illustrated for computer 802, computer systems with multiple CPUs can be used equally effectively. Embodiments of the present invention further incorporate interfaces that each includes separate, fully programmed microprocessors that are used to off-load processing from the CPU 804. Terminal interface 810 is used to directly connect one or more terminals 820 to computer 802 to provide a user interface to the computer 802. These terminals 820, which are able to be non-intelligent or fully programmable workstations, are used to allow system administrators and users to communicate with the information processing system 800. The terminal 820 is also able to consist of user interface and peripheral devices that are connected to computer 802 and controlled by terminal interface hardware included in the terminal I/F 810 that includes video adapters and interfaces for keyboards, pointing devices, and the like.

An operating system (not shown) included in the main memory is a suitable multitasking operating system such as the Linux, UNIX, Windows XP, and Windows Server 2003 operating system. Various embodiments of the present invention are able to use any other suitable operating system. Some embodiments of the present invention utilize architectures, such as an object oriented framework mechanism, that allows instructions of the components of operating system (not shown) to be executed on any processor located within the information processing system 800. The network adapter hardware 812 is used to provide an interface to a network 822. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via CD or DVD, e.g. CD 818, CD ROM, or other form of recordable media, or via any type of electronic transmission mechanism.

### NON-LIMITING EXAMPLES

The present invention can be realized in hardware, software, or a combination of hardware and software. A system according to one embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1-31. (canceled)

32. A neutron and/or gamma sensor circuit comprising:
a photo sensor having an electrical signal output that includes a series capacitive load;
an electrical signal amplifier circuit having an electrical signal input node that is electrically coupled to the electrical signal output of the photo sensor; and
a resistive load having a first input node and a second output node, the first input node being electrically coupled to the electrical signal input node of the electrical signal amplifier circuit and the second output node being electrically coupled to a reference voltage node for the neutron and/or gamma sensor circuit, the resistive load being a substantially smaller resistance than an open circuit input resistance of the electrical signal amplifier circuit at the electrical signal input node, thereby reducing the input resistance of the electrical signal amplifier circuit at the electrical signal input node as seen by the photo sensor's electrical signal output that includes a series capacitive load.

33. The neutron and/or gamma sensor circuit of claim 32, wherein the resistance of the resistive load is selected to substantially reduce an R-C time constant of
the circuit at the electrical signal input node of the electrical signal amplifier circuit coupled with the photo sensor electrical signal output having a series capacitive load, with the resistive load first input node being electrically coupled to the electrical signal input node of the electrical signal amplifier circuit and the resistive load second output node being electrically coupled to a reference voltage node, as compared to
the circuit at the electrical signal input node of the electrical signal amplifier circuit coupled with the photo sensor electrical signal output having a series capacitive load, without the resistive load in the circuit.

34. The neutron and/or gamma sensor circuit of claim 32, wherein an output of the electrical signal amplifier circuit is electrically coupled to an input of an analog-to-digital converter.

35. The neutron and/or gamma sensor circuit of claim 32, wherein the electrical signal amplifier circuit reduces pulse stretching and distortion of an analog signal received at the first input node.

36. The neutron and/or gamma sensor circuit of claim 32, wherein the electrical signal amplifier circuit removes any decay time constant introduced by at least one of capacitive and inductive effects within the electrical signal amplifier circuit.

37. The neutron and/or gamma sensor circuit of claim 32, further comprising an analog to digital converter for conversion of an analog signal from the output of the pre-amp to a digital data signal.

38. The neutron and/or gamma sensor circuit of claim 32, further comprising a digital signal processor for gamma pulse differentiation that one of eliminates or separates gamma signal interference from neutron signal, wherein pulse differentiation is performed through one or more of the following:
pulse height discrimination;
pulse width discrimination;
pulse rise time discrimination;
pulse fall time discrimination.
pulse peak discrimination; and
pulse pile-up filter.

39. (canceled)

40. (canceled)
